(19) United States
(12) Patent Application Publication
(10) Pub. No.: US 2026/0310959 A1
(43) Pub. Date: Oct. 8, 2026

(54) Modular Multi-Domain Machine Learning Models

(71) Applicant: Google LLC, Mountain View, CA (US)

(72) Inventors: Jonas Korbinian Julian Pfeiffer, Zürich (CH); Francesco Piccinno, Zürich (CH); Massimo Nicosia, Zürich (CH); Xinyi Wang, New York, NY (US); Machel Oneil Reid, London (GB); Sebastian Nikolas Ruder, Berlin (DE)

(21) Appl. No.: 19/487,458

(22) PCT Filed: May 22, 2024
(86) PCT No.: PCT/US2024/030551

§ 371 Date: Nov. 24, 2025

Related U.S. Application Data
(60) Provisional application No. 63/503,789, filed on May 23, 2023.

(51) Int. Cl. G06N 3/08

(52) U.S. Cl. CPC G06N 3/08

(57) ABSTRACT

Provided are systems and methods for generating and/or leveraging a modular multi-domain model. According to one aspect of the present disclosure, the proposed multi-domain model employs a plurality of domain-specific sets of parameters during pre-training to separate domain-specific information from domain-agnostic information. According to another aspect of the present disclosure, the proposed model can overcome the limitations of representation drift during fine-tuning, for example by holding fixed some of the shared parameters (e.g., shared parameters included in the decoder).

### RELATED APPLICATIONS

This application claims priority to and the benefit of U.S. Provisional Patent Application No. 63/503,789, filed May 23, 2023. U.S. Provisional Patent Application No. 63/503,789 is hereby incorporated by reference in its entirety.

### FIELD

The present disclosure relates generally to machine learning. More particularly, the present disclosure relates to systems and methods for modular multi-domain machine learning models.

### BACKGROUND

In recent years, machine learning has revolutionized various industries by enabling automation and intelligent decision-making. However, traditional machine learning models often specialize in a single domain or task, making them less adaptable to handle diverse data and different problem domains. This limitation has prompted the development of multi-domain models that can effectively handle multiple tasks or domains, allowing for enhanced flexibility and generalization.

One challenge associated with multi-domain models is the complexity of capturing and representing the intricate relationships and nuances across multiple domains. As these models aim to handle diverse data and tasks, ensuring effective knowledge transfer and shared representations becomes increasingly challenging. The inherent variations in data distributions, feature spaces, and task requirements across domains can lead to difficulties in designing a unified framework that can accommodate the unique characteristics of each domain while still providing a coherent and robust model.

### SUMMARY

Aspects and advantages of embodiments of the present disclosure will be set forth in part in the following description, or can be learned from the description, or can be learned through practice of the embodiments.

One example aspect of the present disclosure is directed to a computer-implemented method to perform improved multi-domain modeling. The method includes generating, by a computing system comprising one or more computing devices, a plurality of domain-specific variants of a machine learning model. Each of the plurality of domain-specific variants of the machine learning model comprises: a shared set of parameters that are shared among the plurality of domain-specific variants of the machine learning model; and a domain-specific set of parameters that are specific to the domain-specific variant of the machine learning model. The method includes training, by the computing system, each of the plurality of domain-specific variants of the machine learning model, wherein said training comprises updating both the shared set of parameters and the domain-specific set of parameters. The method includes finetuning, by the computing system, one or more of the plurality of domain-specific variants of the machine learning model, wherein said finetuning comprises updating at least some of the shared set of parameters while holding fixed the domain-specific set of parameters. The method includes providing, by the computing system, the plurality of domain-specific variants of the machine learning model as an output.

Another example aspect of the present disclosure is directed to a computer-implemented method to perform improved multi-lingual language modeling. The method includes generating, by a computing system comprising one or more computing devices, a plurality of language-specific variants of a language model. Each of the plurality of language-specific variants of the language model comprises: a shared set of parameters that are shared among the plurality of language-specific variants of the language model; and a language-specific set of parameters that are specific to the language-specific variant of the language model. The method includes training, by the computing system, each of the plurality of language-specific variants of the language model, wherein said training comprises updating both the shared set of parameters and the language-specific set of parameters. The method includes finetuning, by the computing system, one or more of the plurality of language-specific variants of the language model, wherein said finetuning comprises updating at least some of the shared set of parameters while holding fixed the language-specific set of parameters. The method includes providing, by the computing system, the plurality of language-specific variants of the language model as an output.

Other aspects of the present disclosure are directed to various systems, apparatuses, non-transitory computer-readable media, user interfaces, and electronic devices.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

The attached Appendix, which is fully incorporated into and forms a portion of this disclosure, describes example implementations of the systems and methods described herein. The present disclosure is not limited to the example implementations described in the attached Appendix.

### BRIEF DESCRIPTION OF THE DRAWINGS

Detailed discussion of embodiments directed to one of ordinary skill in the art is set forth in the specification, which makes reference to the appended figures, in which:

FIG. 1 depicts a flow chart diagram of an example method to perform modular multilingual language modeling according to example embodiments of the present disclosure.

FIG. 2A depicts a block diagram of an example computing system that performs pretraining for modular multilingual language modeling according to example embodiments of the present disclosure.

FIG. 2B depicts a block diagram of an example computing system that performs finetuning for modular multilingual language modeling according to example embodiments of the present disclosure.

FIG. 2C depicts a block diagram of an example computing system that performs finetuning for modular multilingual language modeling according to example embodiments of the present disclosure.

FIG. 2D depicts a block diagram of an example computing system that performs language-specific inference according to example embodiments of the present disclosure.

FIG. 3 depicts a graphical diagram of an example modular multilingual language model architecture according to example embodiments of the present disclosure.

FIG. 4A depicts a block diagram of an example computing system that performs modular multilingual language modeling according to example embodiments of the present disclosure.

FIG. 4B depicts a block diagram of an example computing device according to example embodiments of the present disclosure.

FIG. 4C depicts a block diagram of an example computing device according to example embodiments of the present disclosure.

Reference numerals that are repeated across plural figures are intended to identify the same features in various implementations.

### DETAILED DESCRIPTION

### Overview

Example aspects of the present disclosure are directed to systems and methods for generating and/or leveraging a modular multi-domain model. One example application of the multi-domain model is the multiple languages and in this setting the model can be referred to as a modular multilingual language model. According to one aspect of the present disclosure, the proposed multi-domain model employs a plurality of domain-specific sets of parameters during pre-training to separate domain-specific information from domain-agnostic information. According to another aspect of the present disclosure, the proposed model can overcome the limitations of representation drift during fine-tuning, for example by holding fixed some of the shared parameters (e.g., shared parameters included in the decoder). Example implementations of the proposed model achieve remarkable performance, outperforming certain existing models on natural language understanding and generation tasks in over forty languages. The proposed techniques also significantly improve the rate of generating text in the correct language, addressing the source language hallucination problem demonstrated by existing approaches. The remainder of this description will focus largely on application of the multi-domain model in a multilingual context. However, many other applications are possible, as described elsewhere herein.

More particularly, multilingual pretrained models have shown remarkable performance in natural language understanding tasks across various languages. These models are typically trained on large amounts of unlabeled data from numerous languages. However, a significant drawback of these models is that representations of different languages compete for limited capacity, leading to poor performance with an increasing number of pre-training languages or languages with less training data.

Another challenge arises in natural language generation tasks. Current multilingual models may overfit to the training languages, resulting in a partial loss of their generation ability in the target language. This can cause them to generate text with the correct meaning but in the wrong language, a problem known as source language hallucination.

Thus, existing multilingual models often struggle with generating accurate text in different languages, especially in situations with limited training data. To address this problem, the present disclosure provides a modular multilingual language model. In some implementations, the language model can be a sequence-to-sequence model such as a transformer model and some example implementations of the proposed model can be referred to as a modular multilingual T5 (mmT5).

The proposed model can include or represent the collection of multiple language-specific variants, each designed for a specific language (e.g., a specific natural language such as English, or a specific programming language such as Python). These language-specific variants share a set of parameters that capture common language-independent information. However, each variant can include a language-specific set of parameters that capture language-specific information.

During training (e.g., pre-training), a computing system can update both the shared parameters and the language-specific parameters of each variant. This ensures that the model learns to capture both common patterns across languages and the unique characteristics of each language.

After training (e.g., pre-training), the computing system can perform fine-tuning on one or more of the language-specific variants. During fine-tuning, the shared parameters are updated, but the language-specific parameters are held fixed. This allows direct adaptation of the fine-tuned model to a target language by re-routing to the corresponding language-specific set of parameters.

The present disclosure can therefore generate a plurality of language-specific variants of the language model. These variants can be used to perform various natural language understanding and generation tasks in over 40 languages. Compared to previous models, the proposed models significantly improves the accuracy of generating text in the correct language, especially in situations with limited training data.

The present disclosure also provides solutions to the problem of representation drift in which, during fine-tuning, the shared representations deviate from the fixed language-specific representations in the decoder. As a result of this problem, the modular model can become prone to generating text in the wrong language, similar to non-modular models. To address this issue, example implementations of the present disclosure freeze a specific subset of shared decoder parameters during fine-tuning. This approach leads to significant enhancements in zero-shot cross-lingual generation for modular generative models.

The systems and methods of the present disclosure provide a number of technical effects and benefits. As one example, the proposed techniques enable the use of shared weights. For example, in some implementations, at least some of the model weights are shared across languages. This means that instead of having completely separate sets of weights for each language (e.g., in the form of different models), at least some parameters can be shared for all languages. Sharing weights reduces the machine-learned model size and saves computational resources by avoiding redundant parameter storage and computations.

As another example technical benefit, the proposed techniques enable modular pre-training and fine-tuning. For example, during pre-training, the language-specific parameters and shared parameters are jointly trained. However, during fine-tuning, only the shared parameters are updated, while the language-specific modules are frozen. This approach significantly reduces computational requirements by avoiding the need to fine-tune each of the language-specific sets of parameters. This can conserve computational resources such as processor usage, memory usage, and/or network bandwidth.

As another example technical benefit, to overcome modular representation drift during fine-tuning, example implementations can freeze at least some of the shared parameters of the model, such as, for example, the decoder feed-forward parameters. By freezing these parameters, the drift is mitigated, and the model becomes more compatible with the language-specific modules used during inference. This freeze eliminates the need for computational resources to update and fine-tune the decoder feed-forward parameters during fine-tuning. Inclusion of a decoder in the modular multi-lingual model can enable the model to be applied to various use cases (e.g., more and/or different use cases than an encoder-only model).

The proposed models can be integrated into a number of different practical applications. As one example, the proposed models can be integrated into natural language understanding (NLU) systems to enable accurate understanding of user input in multiple languages. The language-specific variants of the proposed model can be used to process and interpret user queries or commands, providing accurate and contextually relevant responses in the target language. As another example, the proposed models can be integrated into machine translation systems. By leveraging the language-specific variants, the model can better capture the nuances and specific characteristics of different languages, resulting in more accurate translations. The shared parameters help maintain consistency and improve the generalization of translation across languages.

As yet another example, the proposed models can be integrated into multilingual content generation systems. By selecting the appropriate language-specific variant, the system can generate text that adheres to the specific language's grammar, vocabulary, and style. As yet another example, the proposed models can be integrated into multi-lingual information retrieval systems such as search engines. The proposed model can enable users to search and retrieve relevant information in different languages.

Furthermore, although the descriptions herein focus on language, the proposed modular techniques can also be applied to generate a multi-domain model by incorporating domain-specific modules or parameters in each model layer. These domain-specific modules would capture the domain-specific information and enable the model to handle different domains effectively, improving performance across various domains. Similarly, for a multi-modal model, the modular techniques can be extended to include modality-specific modules or parameters in each layer. These modules would capture modality-specific information from different modalities such as text, image, or audio, allowing the model to process and generate content across multiple modalities accurately and coherently.

The term domain can refer to the source of data or the specific problem area that a model is being designed to address. This can encompass everything from the types of features or attributes being used in the model, the distribution of those attributes, and the overall task that the model is being trained to accomplish.

As one example, the proposed multi-domain model can be applied to different domains of image processing or analysis. As examples, “image domains” can be interpreted as categories or types of images that differ in their characteristics due to various factors such as the source of the image, the objects contained within, the environment, or the imaging modality. Examples of different image domains include natural images, medical images, satellite images, microscopy images, infrared images, aerial images, thermal images, LIDAR images, etc.

Additional example multi-domain problems include sentiment analysis across different industries, spam detection across different email providers, object recognition across different image datasets, disease prediction across different populations, fraud detection across different systems, etc. A challenge for the machine learning model is to understand and adapt to the different distributions, patterns, and contexts present in each domain, even when the basic task (like sentiment analysis or object recognition) remains the same.

The proposed models can also be applied to multi-modal problems or tasks. Multi-modal tasks in machine learning are ones that require the understanding and integration of different types of data, such as text, images, and audio. For example, an autonomous vehicle must process visual data from cameras and LIDAR, along with GPS information and possibly even audio signals, to navigate its environment safely. Similarly, a digital assistant must understand spoken language (audio), written language (text), and potentially visual cues from connected devices. Another example is in healthcare, where a diagnosis might be informed by a combination of text-based patient records, numerical lab results, and medical images. These tasks require models capable of handling the nuances and interactions between multiple types of data simultaneously.

With reference now to the Figures, example embodiments of the present disclosure will be discussed in further detail.

### Example Methods

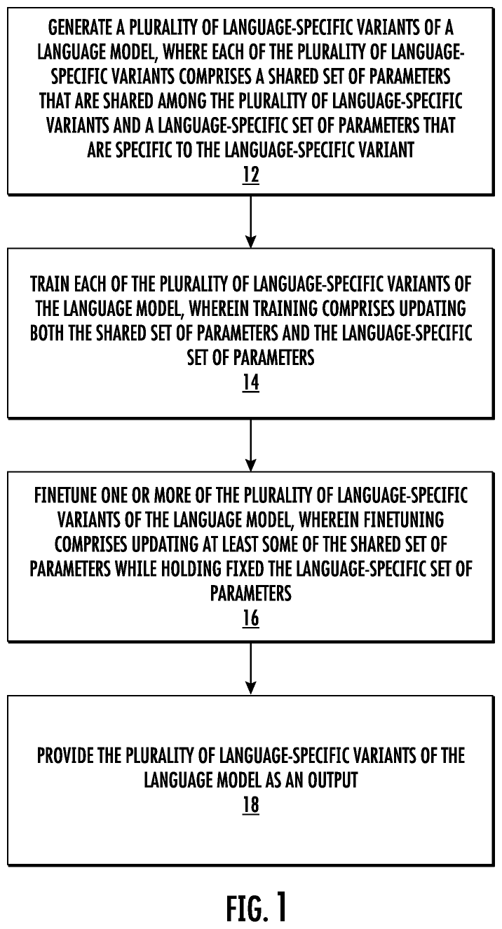

FIG. 1 is a flow chart diagram illustrating the steps of the computer-implemented method for improved multi-lingual language modeling, according to embodiments of the invention. The method is executed by a computing system comprising one or more computing devices. Although FIG. 1 depicts steps performed in a particular order for purposes of illustration and discussion, the methods of the present disclosure are not limited to the particularly illustrated order or arrangement. The various steps of the method can be omitted, rearranged, combined, and/or adapted in various ways without deviating from the scope of the present disclosure.

At 12, the computing system generates a plurality of language-specific variants of a language model. Each language-specific variant includes a shared set of parameters shared among all variants and a language-specific set of parameters specific to that variant. The shared parameters are shared across languages while the language-specific sets of parameters provide the model with language-specific capacity. In some implementations, a table of size N×L, where N is the number of different variants and L is the number of layers in the language model, can be created to store the language-specific sets of parameters.

As one example, the computing system can augment a standard transformer encoder-decoder model with language-specific modules at some or all of the transformer layers. One example transformer model is the TS architecture described Raffel et al., 2020. As one example, for the module architecture, bottleneck adapters can be used as they have been shown to perform better at smaller model sizes compared to other modular methods such as continuous prompts. In some implementations, a module can be placed after the feed-forward component in each layer.

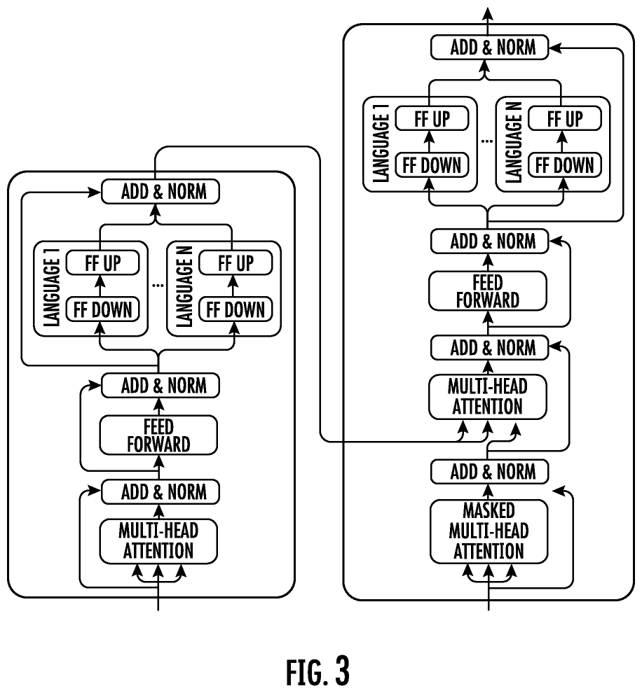

As one example, FIG. 3 depicts a graphical diagram of an example modular multilingual language model architecture according to example embodiments of the present disclosure. As illustrated in FIG. 3, language-specific bottleneck modules can be placed after the Feed Forward layer within each layer of the sequence-to-sequence model (e.g., including both encoder and/or decoder layers).

In some implementations, N×L modular components can be added to the architecture where L is the number of layers of the model and N corresponds to the number of languages which the model is pre-trained on. The transformer weights can be shared across languages while the modular component provides the model with language-specific capacity. During a forward pass, each input can first be passed through the shared transformer weights and then routed through the corresponding language-specific module based on the language of the input. This procedure can be repeated for all transformer layers until the representations are passed to the shared prediction head.

Referring again to FIG. 1, at 14, the computing system can train the language-specific variants of the language model. This can include updating both the shared set of parameters and the language-specific set of parameters. The training may include pre-training each language-specific variant on a pre-training task, enhancing the model's ability to capture language-specific information.

As an example, during a forward pass, the representations of each example are initially passed through the shared parameters. At each modular component, the internal model representation can be routed through the corresponding module of the example's language. The output representations of each module can then be subsequently concatenated and passed through the shared transformer components for the next layer. This procedure can be performed for all transformer layers until the representations are passed to a shared prediction head.

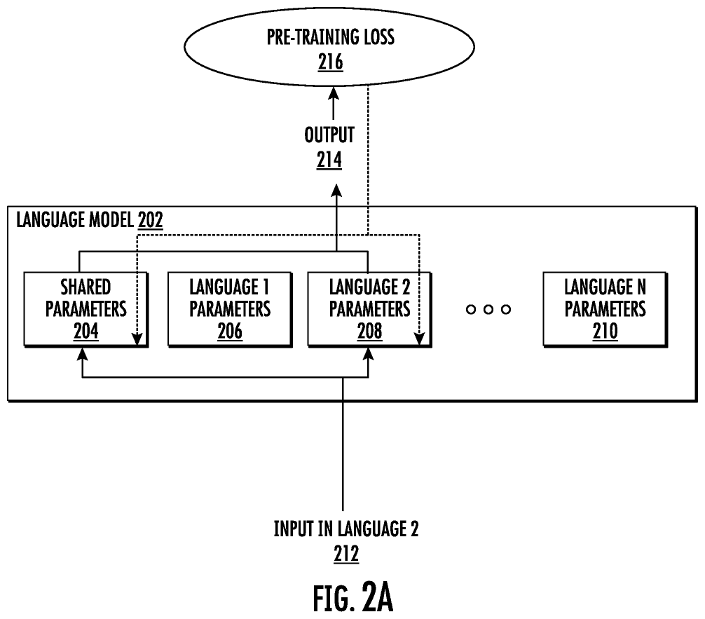

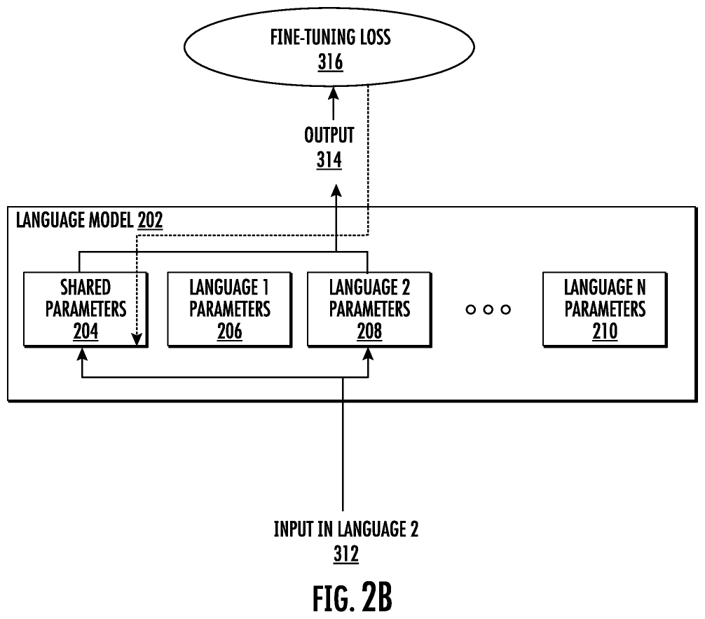

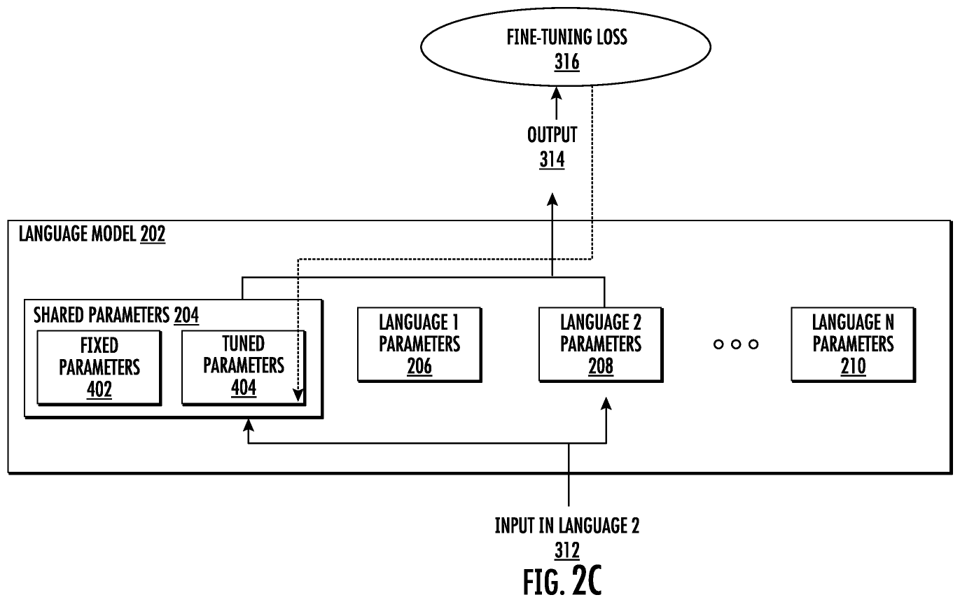

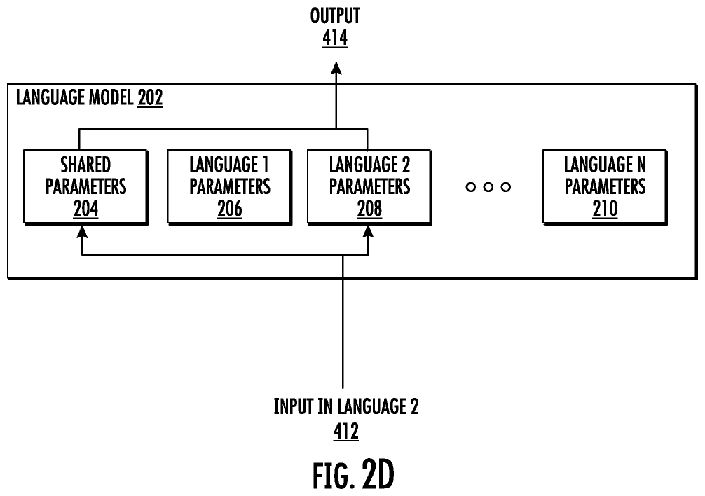

Thus, at 14, the computing system can train (e.g., pre-train) both language-specific modules and shared parameters jointly. FIG. 2A shows a graphical diagram of this process. In FIG. 2A, an example language model 202 includes shared parameters 204 and a number of sets of language-specific parameters 206, 208, 210. The language model 202 receives an input 212 in language 2. The language model uses the shared parameters 204 and the language 2 parameters 208 to process the input 212 to generate an output 214. A pre-training loss 216 can be used to evaluate the output 214. The pre-training loss 216 can be used to update (e.g., via backpropagation) both the shared parameters 204 and the language 2 parameters 208. The illustrated process can be performed for multiple rounds for each language.

Referring again to FIG. 1, at 16, the computing system fine-tunes the language model. For example, one or more of the language-specific variants can undergo a fine-tuning process. During this step, the shared set of parameters is updated while holding fixed the language-specific set of parameters. Thus, at 16, during fine-tuning, the computing system can freeze all language-specific modules and only update the shared parameters. This paradigm allows the computing system to more effectively adapt the fine-tuned model to any of the languages included in the pre-training data by simply switching to the corresponding language-specific module.

FIG. 2B shows a graphical diagram of this process. In FIG. 2B, the example language model 202 includes shared parameters 204 and a number of sets of language-specific parameters 206, 208, 210. The language model 202 receives an input 312 in language 2. The language model uses the shared parameters 204 and the language 2 parameters 208 to process the input 312 to generate an output 314. A fine-tuning loss 316 can be used to evaluate the output 314. In the illustrated example, the fine-tuning loss 316 can be used to update (e.g., via backpropagation) only the shared parameters 204 while the language 2 parameters 208 are held fixed. The illustrated process can be performed for multiple rounds for some or all of the languages.

Referring again to FIG. 1, when fine-tuning the modular model at 16, the model can possibly be subjected to modular representation drift in which the shared parameters that are updated during task-specific training drift away from the modular parameters and become thus less compatible with modules that are used for inference. In practice, this leads to the modular model generating text in the incorrect language, similar to its non-modular counterparts.

In order to ameliorate the drift, some example implementations can freeze at 16 parts of the model, with a focus on the decoder. Thus, in some implementations, in the case of an encoder-decoder model, such as a transformer model, the shared parameters of the encoder model can be updated while at least some shared parameters of the decoder model, such as the decoder feed-forward parameters, are held fixed. For example, freezing the decoder feed-forward parameters provides a significant benefit and almost completely eliminates the source language hallucination problem in modular models.

FIG. 2C shows a graphical diagram of this process. In FIG. 2C, the example language model 202 includes shared parameters 204 and a number of sets of language-specific parameters 206, 208, 210. The language model 202 receives an input 312 in language 2. The language model uses the shared parameters 204 and the language 2 parameters 208 to process the input 312 to generate an output 314. A fine-tuning loss 316 can be used to evaluate the output 314.

In the illustrated example, the shared parameters 204 can include both fixed parameters 402 and tuned parameters 404. The fine-tuning loss 316 can be used to update (e.g., via backpropagation) only the tuned parameters 404 of the shared parameters 204. In contrast, both the language 2 parameters 208 and also the fixed parameters 402 are held fixed. The illustrated process can be performed for multiple rounds for some or all of the languages.

Referring again to FIG. 1, at 18, the computing system provides the language-specific variants as an output. For example, the language-specific variants are associated with different natural languages and can be used for various natural language understanding and generation tasks, offering improved performance in multi-lingual scenarios. For example, at inference, the module corresponding to the target language is used together with the fine-tuned shared parameters. As an example, FIG. 2D depicts a block diagram of this process. In FIG. 2D, an input 412 is received in language 2. Language 2 can be detected based on user input or based on the use of a language detector/classifier. The input 412 can be processed using the shared parameters 204 and the language-specific parameters 208 for language 2 to generate an output 414.

### Example Devices and Systems

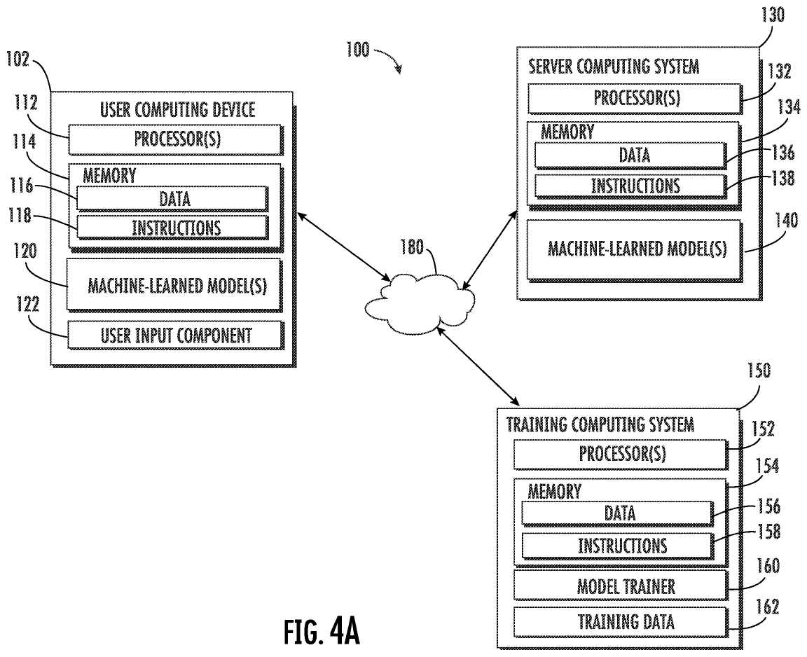

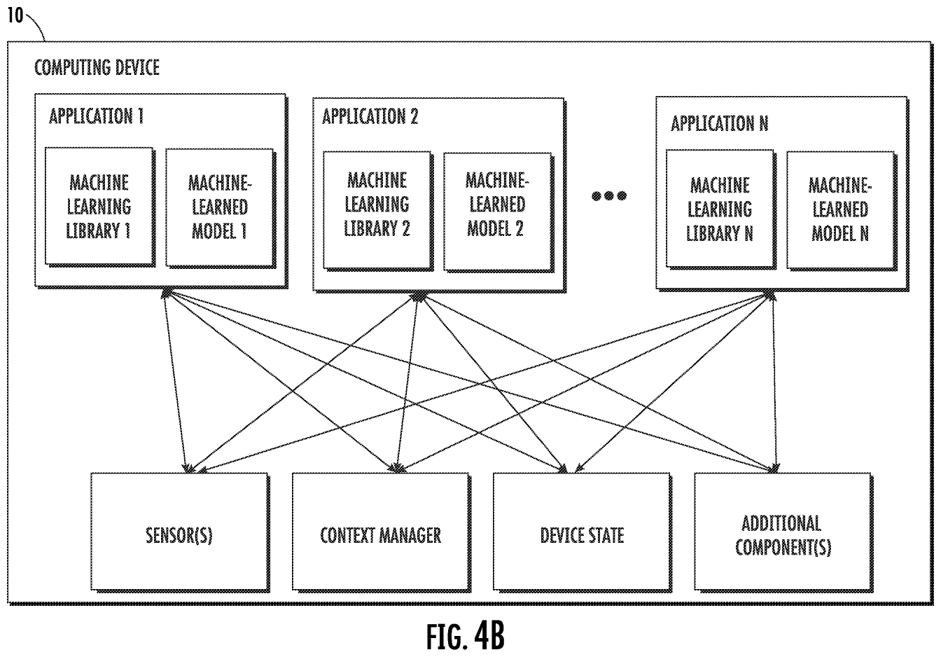

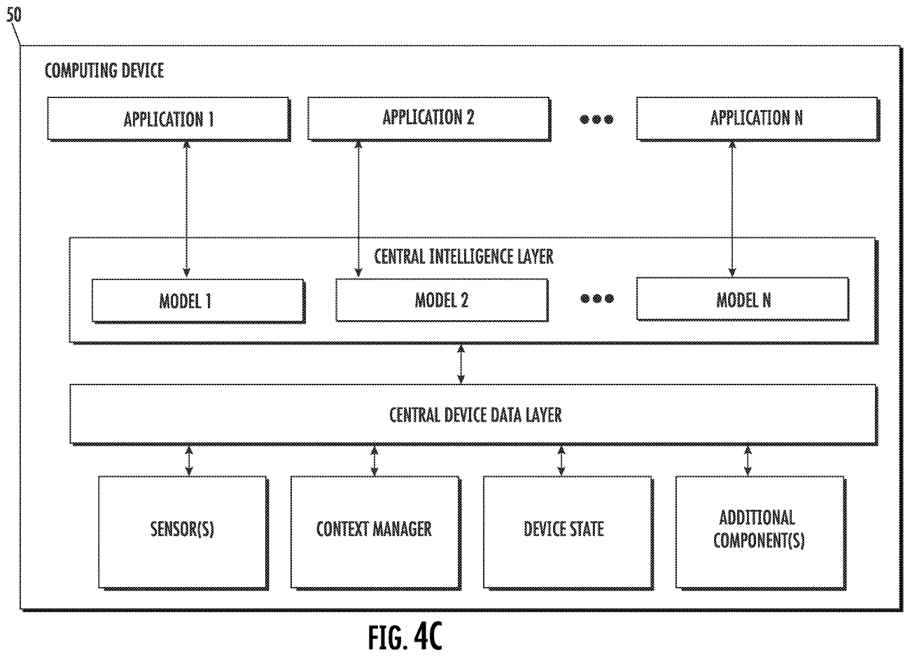

FIG. 4A depicts a block diagram of an example computing system 100 that performs modular multilingual language modelling according to example embodiments of the present disclosure. The system 100 includes a user computing device 102, a server computing system 130, and a training computing system 150 that are communicatively coupled over a network 180.

The user computing device 102 can be any type of computing device, such as, for example, a personal computing device (e.g., laptop or desktop), a mobile computing device (e.g., smartphone or tablet), a gaming console or controller, a wearable computing device, an embedded computing device, or any other type of computing device.

The user computing device 102 includes one or more processors 112 and a memory 114. The one or more processors 112 can be any suitable processing device (e.g., a processor core, a microprocessor, an ASIC, an FPGA, a controller, a microcontroller, etc.) and can be one processor or a plurality of processors that are operatively connected. The memory 114 can include one or more non-transitory computer-readable storage media, such as RAM, ROM, EEPROM, EPROM, flash memory devices, magnetic disks, etc., and combinations thereof. The memory 114 can store data 116 and instructions 118 which are executed by the processor 112 to cause the user computing device 102 to perform operations.

In some implementations, the user computing device 102 can store or include one or more Machine-learned models 120. For example, the Machine-learned models 120 can be or can otherwise include various machine-learned models such as neural networks (e.g., deep neural networks) or other types of machine-learned models, including non-linear models and/or linear models. Neural networks can include feed-forward neural networks, recurrent neural networks (e.g., long short-term memory recurrent neural networks), convolutional neural networks or other forms of neural networks. Some example machine-learned models can leverage an attention mechanism such as self-attention. For example, some example machine-learned models can include multi-headed self-attention models (e.g., transformer models). Example Machine-learned models 120 are discussed with reference to FIGS. 1-2C.

In some implementations, the one or more Machine-learned models 120 can be received from the server computing system 130 over network 180, stored in the user computing device memory 114, and then used or otherwise implemented by the one or more processors 112. In some implementations, the user computing device 102 can implement multiple parallel instances of a single Machine-learned model 120.

Additionally or alternatively, one or more Machine-learned models 140 can be included in or otherwise stored and implemented by the server computing system 130 that communicates with the user computing device 102 according to a client-server relationship. For example, the Machine-learned models 140 can be implemented by the server computing system 140 as a portion of a web service (e.g., a language processing service). Thus, one or more models 120 can be stored and implemented at the user computing device 102 and/or one or more models 140 can be stored and implemented at the server computing system 130.

The user computing device 102 can also include one or more user input components 122 that receives user input. For example, the user input component 122 can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, a traditional keyboard, or other means by which a user can provide user input.

The server computing system 130 includes one or more processors 132 and a memory 134. The one or more processors 132 can be any suitable processing device (e.g., a processor core, a microprocessor, an ASIC, an FPGA, a controller, a microcontroller, etc.) and can be one processor or a plurality of processors that are operatively connected. The memory 134 can include one or more non-transitory computer-readable storage media, such as RAM, ROM, EEPROM, EPROM, flash memory devices, magnetic disks, etc., and combinations thereof. The memory 134 can store data 136 and instructions 138 which are executed by the processor 132 to cause the server computing system 130 to perform operations.

In some implementations, the server computing system 130 includes or is otherwise implemented by one or more server computing devices. In instances in which the server computing system 130 includes plural server computing devices, such server computing devices can operate according to sequential computing architectures, parallel computing architectures, or some combination thereof.

As described above, the server computing system 130 can store or otherwise include one or more Machine-learned models 140. For example, the models 140 can be or can otherwise include various machine-learned models. Example machine-learned models include neural networks or other multi-layer non-linear models. Example neural networks include feed forward neural networks, deep neural networks, recurrent neural networks, and convolutional neural networks. Some example machine-learned models can leverage an attention mechanism such as self-attention. For example, some example machine-learned models can include multi-headed self-attention models (e.g., transformer models). Example models 140 are discussed with reference to FIGS. 1-2C.

The user computing device 102 and/or the server computing system 130 can train the models 120 and/or 140 via interaction with the training computing system 150 that is communicatively coupled over the network 180. The training computing system 150 can be separate from the server computing system 130 or can be a portion of the server computing system 130.

The training computing system 150 includes one or more processors 152 and a memory 154. The one or more processors 152 can be any suitable processing device (e.g., a processor core, a microprocessor, an ASIC, an FPGA, a controller, a microcontroller, etc.) and can be one processor or a plurality of processors that are operatively connected. The memory 154 can include one or more non-transitory computer-readable storage media, such as RAM, ROM, EEPROM, EPROM, flash memory devices, magnetic disks, etc., and combinations thereof. The memory 154 can store data 156 and instructions 158 which are executed by the processor 152 to cause the training computing system 150 to perform operations. In some implementations, the training computing system 150 includes or is otherwise implemented by one or more server computing devices.

The training computing system 150 can include a model trainer 160 that trains the machine-learned models 120 and/or 140 stored at the user computing device 102 and/or the server computing system 130 using various training or learning techniques, such as, for example, backwards propagation of errors. For example, a loss function can be backpropagated through the model(s) to update one or more parameters of the model(s) (e.g., based on a gradient of the loss function). Various loss functions can be used such as mean squared error, likelihood loss, cross entropy loss, hinge loss, and/or various other loss functions. Gradient descent techniques can be used to iteratively update the parameters over a number of training iterations.

In some implementations, performing backwards propagation of errors can include performing truncated backpropagation through time. The model trainer 160 can perform a number of generalization techniques (e.g., weight decays, dropouts, etc.) to improve the generalization capability of the models being trained.

In particular, the model trainer 160 can train the Machine-learned models 120 and/or 140 based on a set of training data 162. In some implementations, if the user has provided consent, the training examples can be provided by the user computing device 102. Thus, in such implementations, the model 120 provided to the user computing device 102 can be trained by the training computing system 150 on user-specific data received from the user computing device 102. In some instances, this process can be referred to as personalizing the model.

The model trainer 160 includes computer logic utilized to provide desired functionality. The model trainer 160 can be implemented in hardware, firmware, and/or software controlling a general purpose processor. For example, in some implementations, the model trainer 160 includes program files stored on a storage device, loaded into a memory and executed by one or more processors. In other implementations, the model trainer 160 includes one or more sets of computer-executable instructions that are stored in a tangible computer-readable storage medium such as RAM, hard disk, or optical or magnetic media.

The network 180 can be any type of communications network, such as a local area network (e.g., intranet), wide area network (e.g., Internet), or some combination thereof and can include any number of wired or wireless links. In general, communication over the network 180 can be carried via any type of wired and/or wireless connection, using a wide variety of communication protocols (e.g., TCP/IP, HTTP, SMTP, FTP), encodings or formats (e.g., HTML, XML), and/or protection schemes (e.g., VPN, secure HTTP, SSL).

The machine-learned models described in this specification may be used in a variety of tasks, applications, and/or use cases.

In some implementations, the input to the machine-learned model(s) of the present disclosure can be image data. The machine-learned model(s) can process the image data to generate an output. As an example, the machine-learned model(s) can process the image data to generate an image recognition output (e.g., a recognition of the image data, a latent embedding of the image data, an encoded representation of the image data, a hash of the image data, etc.). As another example, the machine-learned model(s) can process the image data to generate an image segmentation output. As another example, the machine-learned model(s) can process the image data to generate an image classification output. As another example, the machine-learned model(s) can process the image data to generate an image data modification output (e.g., an alteration of the image data, etc.). As another example, the machine-learned model(s) can process the image data to generate an encoded image data output (e.g., an encoded and/or compressed representation of the image data, etc.). As another example, the machine-learned model(s) can process the image data to generate an upscaled image data output. As another example, the machine-learned model(s) can process the image data to generate a prediction output.

In some implementations, the input to the machine-learned model(s) of the present disclosure can be text or natural language data. The machine-learned model(s) can process the text or natural language data to generate an output. As an example, the machine-learned model(s) can process the natural language data to generate a language encoding output. As another example, the machine-learned model(s) can process the text or natural language data to generate a latent text embedding output. As another example, the machine-learned model(s) can process the text or natural language data to generate a translation output. As another example, the machine-learned model(s) can process the text or natural language data to generate a classification output. As another example, the machine-learned model(s) can process the text or natural language data to generate a textual segmentation output. As another example, the machine-learned model(s) can process the text or natural language data to generate a semantic intent output. As another example, the machine-learned model(s) can process the text or natural language data to generate an upscaled text or natural language output (e.g., text or natural language data that is higher quality than the input text or natural language, etc.). As another example, the machine-learned model(s) can process the text or natural language data to generate a prediction output.

In some implementations, the input to the machine-learned model(s) of the present disclosure can be speech data. The machine-learned model(s) can process the speech data to generate an output. As an example, the machine-learned model(s) can process the speech data to generate a speech recognition output. As another example, the machine-learned model(s) can process the speech data to generate a speech translation output. As another example, the machine-learned model(s) can process the speech data to generate a latent embedding output. As another example, the machine-learned model(s) can process the speech data to generate an encoded speech output (e.g., an encoded and/or compressed representation of the speech data, etc.). As another example, the machine-learned model(s) can process the speech data to generate an upscaled speech output (e.g., speech data that is higher quality than the input speech data, etc.). As another example, the machine-learned model(s) can process the speech data to generate a textual representation output (e.g., a textual representation of the input speech data, etc.). As another example, the machine-learned model(s) can process the speech data to generate a prediction output.

In some implementations, the input to the machine-learned model(s) of the present disclosure can be latent encoding data (e.g., a latent space representation of an input, etc.). The machine-learned model(s) can process the latent encoding data to generate an output. As an example, the machine-learned model(s) can process the latent encoding data to generate a recognition output. As another example, the machine-learned model(s) can process the latent encoding data to generate a reconstruction output. As another example, the machine-learned model(s) can process the latent encoding data to generate a search output. As another example, the machine-learned model(s) can process the latent encoding data to generate a reclustering output. As another example, the machine-learned model(s) can process the latent encoding data to generate a prediction output.

In some implementations, the input to the machine-learned model(s) of the present disclosure can be statistical data. Statistical data can be, represent, or otherwise include data computed and/or calculated from some other data source. The machine-learned model(s) can process the statistical data to generate an output. As an example, the machine-learned model(s) can process the statistical data to generate a recognition output. As another example, the machine-learned model(s) can process the statistical data to generate a prediction output. As another example, the machine-learned model(s) can process the statistical data to generate a classification output. As another example, the machine-learned model(s) can process the statistical data to generate a segmentation output. As another example, the machine-learned model(s) can process the statistical data to generate a visualization output. As another example, the machine-learned model(s) can process the statistical data to generate a diagnostic output.

In some implementations, the input to the machine-learned model(s) of the present disclosure can be sensor data. The machine-learned model(s) can process the sensor data to generate an output. As an example, the machine-learned model(s) can process the sensor data to generate a recognition output. As another example, the machine-learned model(s) can process the sensor data to generate a prediction output. As another example, the machine-learned model(s) can process the sensor data to generate a classification output. As another example, the machine-learned model(s) can process the sensor data to generate a segmentation output. As another example, the machine-learned model(s) can process the sensor data to generate a visualization output. As another example, the machine-learned model(s) can process the sensor data to generate a diagnostic output. As another example, the machine-learned model(s) can process the sensor data to generate a detection output.

In some cases, the machine-learned model(s) can be configured to perform a task that includes encoding input data for reliable and/or efficient transmission or storage (and/or corresponding decoding). For example, the task may be an audio compression task. The input may include audio data and the output may comprise compressed audio data. In another example, the input includes visual data (e.g. one or more images or videos), the output comprises compressed visual data, and the task is a visual data compression task. In another example, the task may comprise generating an embedding for input data (e.g. input audio or visual data).

In some cases, the input includes visual data and the task is a computer vision task. In some cases, the input includes pixel data for one or more images and the task is an image processing task. For example, the image processing task can be image classification, where the output is a set of scores, each score corresponding to a different object class and representing the likelihood that the one or more images depict an object belonging to the object class. The image processing task may be object detection, where the image processing output identifies one or more regions in the one or more images and, for each region, a likelihood that region depicts an object of interest. As another example, the image processing task can be image segmentation, where the image processing output defines, for each pixel in the one or more images, a respective likelihood for each category in a predetermined set of categories. For example, the set of categories can be foreground and background. As another example, the set of categories can be object classes. As another example, the image processing task can be depth estimation, where the image processing output defines, for each pixel in the one or more images, a respective depth value. As another example, the image processing task can be motion estimation, where the network input includes multiple images, and the image processing output defines, for each pixel of one of the input images, a motion of the scene depicted at the pixel between the images in the network input.

In some cases, the input includes audio data representing a spoken utterance and the task is a speech recognition task. The output may comprise a text output which is mapped to the spoken utterance. In some cases, the task comprises encrypting or decrypting input data. In some cases, the task comprises a microprocessor performance task, such as branch prediction or memory address translation.

FIG. 4A illustrates one example computing system that can be used to implement the present disclosure. Other computing systems can be used as well. For example, in some implementations, the user computing device 102 can include the model trainer 160 and the training dataset 162. In such implementations, the models 120 can be both trained and used locally at the user computing device 102. In some of such implementations, the user computing device 102 can implement the model trainer 160 to personalize the models 120 based on user-specific data.

FIG. 4B depicts a block diagram of an example computing device 10 that performs according to example embodiments of the present disclosure. The computing device 10 can be a user computing device or a server computing device.

The computing device 10 includes a number of applications (e.g., applications 1 through N). Each application contains its own machine learning library and machine-learned model(s). For example, each application can include a machine-learned model. Example applications include a text messaging application, an email application, a dictation application, a virtual keyboard application, a browser application, etc.

As illustrated in FIG. 4B, each application can communicate with a number of other components of the computing device, such as, for example, one or more sensors, a context manager, a device state component, and/or additional components. In some implementations, each application can communicate with each device component using an API (e.g., a public API). In some implementations, the API used by each application is specific to that application.

FIG. 4C depicts a block diagram of an example computing device 50 that performs according to example embodiments of the present disclosure. The computing device 50 can be a user computing device or a server computing device.

The computing device 50 includes a number of applications (e.g., applications 1 through N). Each application is in communication with a central intelligence layer. Example applications include a text messaging application, an email application, a dictation application, a virtual keyboard application, a browser application, etc. In some implementations, each application can communicate with the central intelligence layer (and model(s) stored therein) using an API (e.g., a common API across all applications).

The central intelligence layer includes a number of machine-learned models. For example, as illustrated in FIG. 4C, a respective machine-learned model can be provided for each application and managed by the central intelligence layer. In other implementations, two or more applications can share a single machine-learned model. For example, in some implementations, the central intelligence layer can provide a single model for all of the applications. In some implementations, the central intelligence layer is included within or otherwise implemented by an operating system of the computing device 50.

The central intelligence layer can communicate with a central device data layer. The central device data layer can be a centralized repository of data for the computing device 50. As illustrated in FIG. 4C, the central device data layer can communicate with a number of other components of the computing device, such as, for example, one or more sensors, a context manager, a device state component, and/or additional components. In some implementations, the central device data layer can communicate with each device component using an API (e.g., a private API).

### Additional Disclosure

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations and/or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

1. A computer-implemented method to perform improved multi-domain modeling, the method comprising:
generating, by a computing system comprising one or more computing devices, a plurality of domain-specific variants of a machine learning model, wherein each of the plurality of domain-specific variants of the machine learning model comprises:
a shared set of parameters that are shared among the plurality of domain-specific variants of the machine learning model; and
a domain-specific set of parameters that are specific to the domain-specific variant of the machine learning model;
training, by the computing system, each of the plurality of domain-specific variants of the machine learning model, wherein said training comprises updating both the shared set of parameters and the domain-specific set of parameters;
finetuning, by the computing system, one or more of the plurality of domain-specific variants of the machine learning model, wherein said finetuning comprises updating at least some of the shared set of parameters while holding fixed the domain-specific set of parameters; and
providing, by the computing system, the plurality of domain-specific variants of the machine learning model as an output.

2. The computer-implemented method of claim 1, wherein training, by the computing system, each of the plurality of domain-specific variants of the machine learning model comprises pre-training by the computing system, each of the plurality of domain-specific variants of the machine learning model on a pre-training task.

3. The computer-implemented method of claim 1, wherein the machine learning model comprises an encoder model and a decoder model, and wherein updating at least some of the shared set of parameters during said finetuning comprises updating the shared parameters of the encoder model while holding fixed at least some of the shared parameters of the decoder model.

4. The computer-implemented method of claim 3, wherein the machine learning model comprises a transformer model.

5. The computer-implemented method of claim 4, wherein the least some of the shared parameters of the decoder model that are held fixed comprise decoder feed-forward parameters.

6. The computer-implemented method of claim 1, wherein the plurality of domain-specific sets of parameters are stored in a table of size N×L, where N is a number of different variants and L is a number of layers in the machine learning model.

7. The computer-implemented method of claim 1, wherein, at each of a number of layers of the machine learning model, an input representation is (1) modified using the shared set of parameters; and then (2) modified using the domain-specific set of parameters that correspond to an input domain.

8. The computer-implemented method of claim 1, wherein the plurality of domain-specific variants are respectively associated with a plurality of different image domains.

9. A computer-implemented method to perform improved multi-lingual language modeling, the method comprising:
generating, by a computing system comprising one or more computing devices, a plurality of language-specific variants of a language model, wherein each of the plurality of language-specific variants of the language model comprises:
a shared set of parameters that are shared among the plurality of language-specific variants of the language model; and
a language-specific set of parameters that are specific to the language-specific variant of the language model;
training, by the computing system, each of the plurality of language-specific variants of the language model, wherein said training comprises updating both the shared set of parameters and the language-specific set of parameters;
finetuning, by the computing system, one or more of the plurality of language-specific variants of the language model, wherein said finetuning comprises updating at least some of the shared set of parameters while holding fixed the language-specific set of parameters; and
providing, by the computing system, the plurality of language-specific variants of the language model as an output.

10. The computer-implemented method of claim 9, wherein training, by the computing system, each of the plurality of language-specific variants of the language model comprises pre-training by the computing system, each of the plurality of language-specific variants of the language model on a pre-training task.

11. The computer-implemented method of claim 9, wherein the language model comprises an encoder model and a decoder model, and wherein updating at least some of the shared set of parameters during said finetuning comprises updating the shared parameters of the encoder model while holding fixed at least some of the shared parameters of the decoder model.

12. The computer-implemented method of claim 11, wherein the language model comprises a transformer model.

13. The computer-implemented method of claim 12, wherein the least some of the shared parameters of the decoder model that are held fixed comprise decoder feed-forward parameters.

14. The computer-implemented method of claim 9, wherein the plurality of language-specific sets of parameters are stored in a table of size N×L, where N is a number of different variants and L is a number of layers in the language model.

15. The computer-implemented method of claim 9, wherein, at each of a number of layers of the language model, an input representation is (1) modified using the shared set of parameters; and then (2) modified using the language-specific set of parameters that correspond to an input language.

16. The computer-implemented method of claim 9, wherein the plurality of language-specific variants are respectively associated with a plurality of different natural languages.

17. A computer-implemented method to perform improved multi-modality modeling, the method comprising:
generating, by a computing system comprising one or more computing devices, a plurality of modality-specific variants of a multi-modality model, wherein each of the plurality of modality-specific variants of the multi-modality model comprises:
a shared set of parameters that are shared among the plurality of modality-specific variants of the multi-modality model; and
a modality-specific set of parameters that are specific to the modality-specific variant of the multi-modality model;
training, by the computing system, each of the plurality of modality-specific variants of the multi-modality model, wherein said training comprises updating both the shared set of parameters and the modality-specific set of parameters;
finetuning, by the computing system, one or more of the plurality of modality-specific variants of the multi-modality model, wherein said finetuning comprises updating at least some of the shared set of parameters while holding fixed the modality-specific set of parameters; and
providing, by the computing system, the plurality of modality-specific variants of the multi-modality model as an output.

18. (canceled)

19. (canceled)
